(19) United States
(12) Patent Application Publication
(10) Pub. No.: US 2021/0205850 A1
(43) Pub. Date: Jul. 8, 2021

(54) DE-AGGLOMERATING SIEVE WITH DE-IONIZATION

(71) Applicant: HEWLETT-PACKARD DEVELOPMENT COMPANY, L.P., Spring, TX (US)

(72) Inventors: Bradley B BRANHAM, Vancouver, WA (US); Justin M ROMAN, Vancouver, WA (US); Wesley R SCHALK, Vancouver, WA (US); Samantha KANG, Vancouver, WA (US); Alexander LAWS, Vancouver, WA (US)

(73) Assignee: HEWLETT-PACKARD DEVELOPMENT COMPANY, L.P., Houston, TX (US)

(21) Appl. No.: 16/075,631

(22) PCT Filed: Apr. 11, 2017
(86) PCT No.: PCT/US2017/026949

§ 371 Date: Aug. 4, 2018

(51) Int. Cl. B07B 11/02; B07B 1/22; B07B 7/06; H05F 3/04; B33Y 30/00; B33Y 40/00; B29C 64/321; B29C 64/314

(52) U.S. Cl. CPC B07B 11/02; B07B 1/22; B07B 7/06; B29C 64/314; B33Y 30/00; B33Y 40/00; B29C 64/321; H05F 3/04

(57) ABSTRACT

A device to de-ionize a build material, a method to de-ionize, and a 3D printer system including the device are disclosed. The device includes a housing having an outlet port and an enclosed sieve within the housing. An inlet port is coupled to a first end the enclosed sieve to provide the build material. A drive actuator is coupled to a second end of the enclosed sieve. The housing and the enclosed sieve may be made of a polymer selected from the build material and a chemically-similar polymer to the build material.

### BACKGROUND

Repeatability, quality control, and recycling are many aspects of modern manufacturing systems and material design. Innovative technologies such as three-dimensional (3D) printing and other new fabrication processes are changing the manufacturing landscape by creating parts using additive technology. Additive technologies use material powders, particulate materials, or powder-like materials as build material that is applied in multiple layers and sintered, fused, or otherwise transformed into a solid material. Accurately applying such build material and recovery of any excess build materials are desired to be done as effectively, efficiently, and low cost as possible.

### BRIEF DESCRIPTION OF THE DRAWINGS

The disclosure is better understood with respect to the following drawings. The elements of the drawings are not accordingly to scale relative to each other. Rather, emphasis has instead been placed upon illustrating the claimed subject matter. Furthermore, like reference numerals designate corresponding similar parts through the several views. For brevity, reference numbers repeated in latter drawings may not be re-described.

FIG. 1 is a schematic illustration of an example device that includes a de-agglomerating sieve with de-ionization;

FIG. 2 is a schematic illustration of the device in FIG. 1 with electrodes to provide active de-ionization of the build material;

FIG. 3 is a pictorial illustration of a cataracting granular flow within an example de-agglomerating sieve;

FIG. 4 is an illustration of an example de-agglomerating sieve;

FIG. 5 is an exploded view of the example de-agglomerating sieve of FIG. 4;

FIG. 6 is a schematic view of a first type of de-agglomerating sieve operation in one example;

FIG. 7 is a schematic view of a second type of de-agglomerating sieve operation in a second example;

FIG. 8 is a schematic view of a third type of de-agglomerating sieve operation in a third example;

FIGS. 9A and 9B are perspective views of an example device supporting both active and passive de-ionization along with de-agglomeration;

FIG. 10A is a block diagram of an example 3D printer system with an example device of FIGS. 1, 9A and 9B.

FIG. 10B is a more detailed illustration of use of the example device of FIGS. 1, 9A and 9B in a 3D printing system;

FIGS. 11A and 11B are example procedures that may be performed to use the example devices to deliver de-agglomerated and de-ionized build material; and

FIGS. 12A and 12B are example procedures that may be performed to make an example device with a de-agglomerating sieve with de-ionization.

### DETAILED DESCRIPTION

There are numerous issues with delivering build material in 3D printing systems or other fabrication systems. For example, the build material may have a wide distribution of particle sizes. Smaller sized particles may cluster into larger sized particles due to static charges, moisture, and contaminants from recycled material, just to name a few. Further, the particle morphology may tend to allow particles to interlock mechanically to form larger particles with smaller particles adhering to the surface of the larger particles. Early attempts to separate build material with vibrating flat screen sieves actually may lead to agglomerate particles due to gravitational forces causing compression within build material piles placed on the screen. This compression can lead to interfacial cohesive forces that may cause the build material particles to bind together. For example, “agglomeration” may occur when there is interfacial cohesion between build material particles that cannot be overcome by the kinetic body forces of individual particles. Often, the kinetic motion of the individual particles may be identical to the motion of the aggregate and thus this aggregate is termed “agglomerated”. The interfacial cohesion may be from electrical, magnetic, hydraulic surface tension, or other forces. Simply breaking apart the aggregate may not prevent re-agglomeration as the individual particles may still be charged and reaggregate with other charged particles.

When build material is aggregated into larger and smaller particles, it may be difficult to accurately spread the build material on a working bed of a 3D printer without at times creating grooves, gouges, and otherwise uneven spreading. Further, when aggregated, the build material may be inconsistent when heated to sinter, fuse, or melt the material as the varying size of the particles may vary the time it takes for an energy source such as a laser or I/R lamp to properly alter the material. Further, annealing or cooling times of the sintered, fused, or melted material may be affected by the particle size and accordingly the final mechanical properties of the fabricated product. Having a fast, repeatable, and reliable method of providing a build material of consistent sized and de-ionized particles may help new manufacturing technologies become mainstream.

Disclosed and discussed below is a new type of sieve that allows for both de-agglomeration as well as de-ionization or electrical neutralization, passively and actively, of build material. Such a de-agglomerating sieve may be constructed using 3D printing technology to allow for use with several different types of build materials, such as polymer powders, particulate materials, and powder-like materials. A de-agglomerating sieve may be made modular for easy repair and exchange in high volume operations.

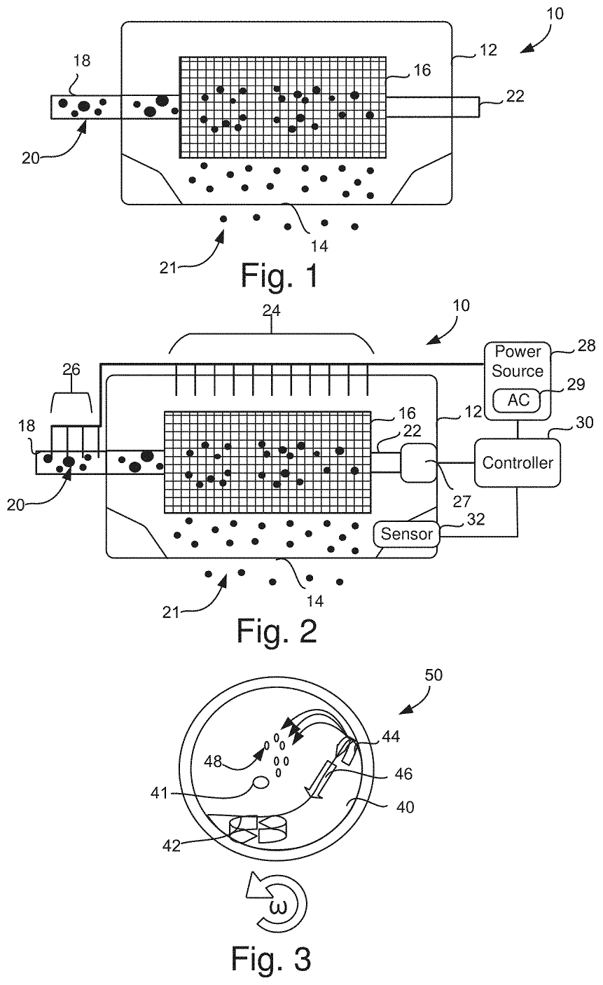

FIG. 1 is a schematic illustration of an example device 10 that includes an enclosed sieve 16 for de-agglomeration with passive de-ionization of a build material 20 by having at least the enclosed sieve 16 made of a polymer selected from the build material or from a chemically-similar polymer. Chemically-similar (or molecularly-similar) in this disclosure refers to the similarity of chemical elements, molecules or chemical compounds with respect to either structural or functional qualities, i.e. the effect that the chemical compound has on reaction partners in non-biological settings. The chemically-similar polymer may be a functional analog of a similar chemical structure but differing from the build material in respect of a certain component or components. For instance, the components may be one or more atoms, functional groups, or substructures replaced with other atoms, groups, or substructures. Such a functional analog has similar physical and chemical properties, particularly with respect to ionization.

In one example, the enclosed sieve 16 may form an enclosed screen around the outer cylindrical surface with a cylindrical void inside the screen. More generally, the enclosed sieve 16 may have a surface that encloses a void that receives build material 20 and has one or more arrays of openings in the enclosed surface that allows de-aggregated build material 20 to exit as processed build material 21. For ease of discussion and as just one example, the enclosed sieve 16 may be described herein as cylindrical but other shapes that form an enclosure are possible. For instance, the shape may be a circular globe or tapered cone surface instead of a cylinder.

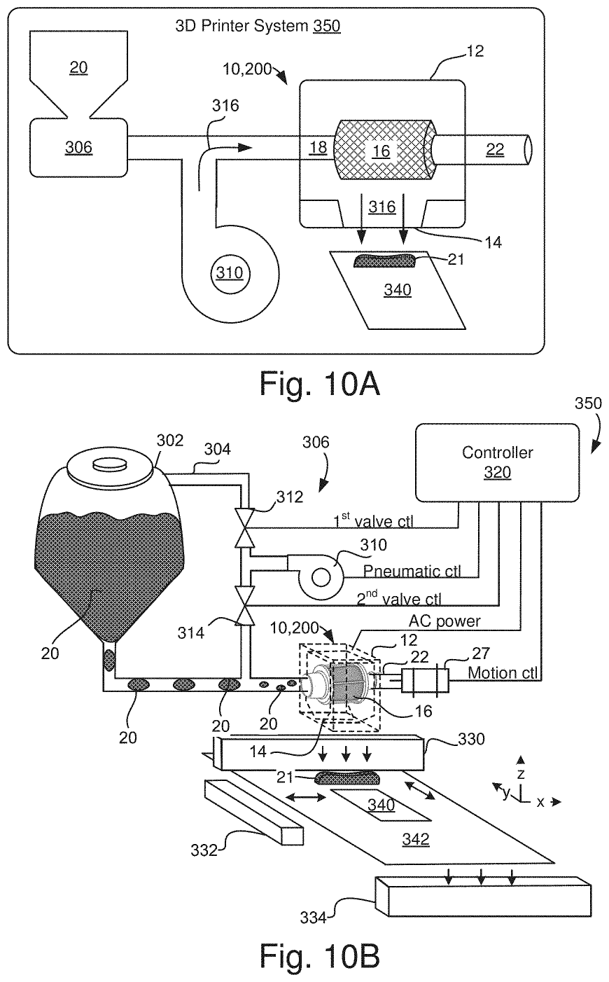

An inlet port 18 extends from outside of a containment housing 12 to a first end of the enclosed sieve 16 within housing 12. The housing 12 includes an outlet port 14 to allow for the removal or exiting of the processed build material 21, which has been de-agglomerated and de-ionized. A positive pneumatic air flow (316, FIG. 10A) creating a pressure differential may be maintained between the inlet port 18 and the outlet port 14 by an air flow mechanism or pneumatic source (310, FIG. 10A) to provide advection or transfer of the build material 20 to the enclosed sieve and further transfer of the processed build material 21 through the outlet port 14. The internal volume of the cylinder void is designed to allow for the volume of powder flowing through the system and the headspace of air being maintained. In addition to the screen, the enclosed sieve 16 may also include support members or internal fins, blades, or other structures (not shown) to help with mixing and de-agglomeration of the build material 20 as well as structural support of the surface.

A drive actuator 22 may extend from inside or outside the containment housing 12 to a second end of the enclosed sieve 16. The drive actuator 22 may be one of a drive shaft, a belt drive, a gear drive, etc. themselves or coupled to a kinetic motive source, such as a motion actuator 27. The motion actuator 27 may be used to convey partial or full rotary motion to the enclosed sieve 16 and/or the build material 20 within to de-agglomerate or separate the build material 20. In some examples, the inlet port 18 and the housing 12 may also be made of the same or chemically-similar polymer as the build material 20. By using the same or chemically-similar polymer as the build material 20, the inlet port 18, the housing 12, and the enclosed sieve 16 may all provide passive de-ionization by contact de-electrification that discharges the powder.

FIG. 2 is a schematic illustration of the device 10 in FIG. 1 with a first and second set of electrodes 24, 26 to provide active de-ionization of the build material 20. The first set of electrodes 24 may extend from outside of the housing 12 into the inside of the housing 12. In other examples, the first set of electrodes 24 may just extend into the housing 12 and not outside the housing 12. The distinction between inlet electrodes 26 and housing electrodes 24 allows for engineering optimization of de-ionization based on which parts are modular and replaceable. In one example, the electrodes 24, 26 are connected to a grounded power source. In other examples, an active power source 28 may have a direct current (DC) component and an alternating current (AC) voltage component 29 may be coupled to the one or both first and second set of electrodes 24, 26. This AC voltage component 29 may reside on top of the DC component. The AC voltage component 29 may be in the form of a bipolar square wave in one example to actively discharge the build material 20. Other AC shapes such as sinusoidal, triangular, etc. may also be used. Using the AC voltage component 29 allows an equilibrium condition to be created by frequent generation of positive aero-ions (cations) and negative aero-ions (ions) that neutralize particles of build material 20 traveling in the pneumatic flow. The interacting surfaces of the particles of build material 20 in their relative motion in the air flow (i.e. powder triboloby) yields bimodal polarity charges within an aggregate of particles. In one example, a feedback sensor 32 within the housing 12 measuring ion-charge balance may be included in an electronics subsystem that includes a controller 30. The feedback sensor may instruct the controller 30 to adjust at least one of the DC voltage level, the AC voltage level, and the AC frequency of the power source 28 to achieve adequate electrical equilibrium based on the measured ion-charge balance from feedback sensor 32.

In this example, the motion actuator 27 is coupled to a drive actuator 22 to rotate, partially rotate, or vibrate the enclosed sieve 16. The motion actuator 27 may be coupled to the controller 30. In other examples, the motion actuator 27 may be outside the housing 12 and may also be controlled independently from controller 30.

FIG. 3 is an example pictorial illustration 50 of a cataracting granular flow and build material inertia within an example enclosed sieve 16 to help diagrammatically illustrate and describe how the enclosed sieve may operate in one non-limiting example. FIG. 3 includes different agglomerations of build material 20 and its flow within the cylindrical void. The cylinder of enclosed sieve 16 in this example may rotate with a frequency ω creating a rotational velocity von the sieve walls of the cylinder based on the cylinder diameter. As the cylinder rotates counter-clockwise in this example, a mass of build material 20 forms a centrifugal slug 40 that clings to the screen and ejects smaller aggregates such as a “Brazil nut” 41 and airborne particles 48 with very high inertia. The centrifugal slug 40 also creates a free-flowing active fluidized top layer 42 and includes a gravitational circulation 44 and cascading sheer layers 46.

In the cylinder void, there may be many ‘peculiar motions’ that a particle of the build material may take depending on the powder flow regime. “Peculiar motion” in powder flow physics generally refers to a motion that has at least one component of its velocity different from the components of the aggregate flow of the powder, particulate, or powder-like material. As the cylinder rotates, counter-clockwise in this example, the centrifugal slug 40 rises on the right as a non-shearing aggregate that follows the cylinder. Smaller particles that are size segregated from the larger particles and the agglomerate easily pass through the screen surface of the enclosed sieve 16. As the cylinder rotates, larger particles move up and smaller particles move under the larger particles preventing them from returning to the surface of the cylinder. This peculiar motion of larger particles occurs until agglomerates, Brazil nut 41 and airborne particles 48, are ejected back into the internal void of the cylinder. Smaller particles of build material 20 are compressed against the screen and passively de-ionized due the screen being made of the same or chemically-similar material, and then flow out of the cylinder towards outlet port 14 as processed build material 21. If active de-ionization is invoked, the ejected smaller particles of the processed build material 21 are further de-ionized due to the positive and negative areo-ions within the housing.

At the top of the gravitational hill of centrifugal slug 40, there are three distinct peculiar motions that the build material particles may have. If a particle has moderate or no inertia, it goes “over the top” as gravitational circulation 44. Any over the top particles are recirculated into cascading shear layers 46. If a smaller particle has sufficient high inertia it becomes airborne as shown by airborne particles 48. However, most of the particles form a powder shear layer at the surface and this cascading shear layer 46 “avalanches” back onto a recirculation shear layer 42 above the surface of centrifugal plug 40.

As the centrifugal slug 40 rises on the right, the centrifugal force in the radial direction is more prominent than the gravitational force acting on the centrifugal slug 40. The peculiar radial velocity due to size segregation may become more prominent such that larger agglomerates are ejected into the inner part or void of the cylinder, such as Brazil nut 41. This is often called the “Brazil nut effect.” Due to this Brazil nut effect, such agglomerates travel toward the center of the cylinder and out onto the surface of the centrifugal slug 40.

Once at the surface, the dynamic state (velocity, acceleration) of the agglomerate of Brazil nut 41 is radically different than the powder or particulates flowing at the surface as free-flowing active fluidized top layer 42. This difference prevents the agglomerate Brazil nut 41 from being re-absorbed into the aggregate motion. Instead, the Brazil nut 41 is subjected to the inertial ‘hammer’ of the free-flowing active fluidized top layer 42 and thus bounces and spins. This rotation of top layer 42 spins the agglomerate Brazil nut 41 and may kick it up into the free air above the surface. The Brazil nut 41 falls back down and is ‘hammered again.’ Each impact overcomes some of the cohesive forces binding the agglomerate of Brazil nut 41. Liberated particles break loose from the agglomerate and may be re-absorbed into the cataracting powder flow. In addition, use of an enclosed cylinder in cataracting flow allows the high inertia airborne particles 48 ejected into the hollow volume of the cylinder to ‘sandblast’ the agglomerate of Brazil nut 41. This provides a second inertial ‘hammer’ or ‘tapper’ and any loosened particles from this tapper may be also re-absorbed into the cataracting powder flow.

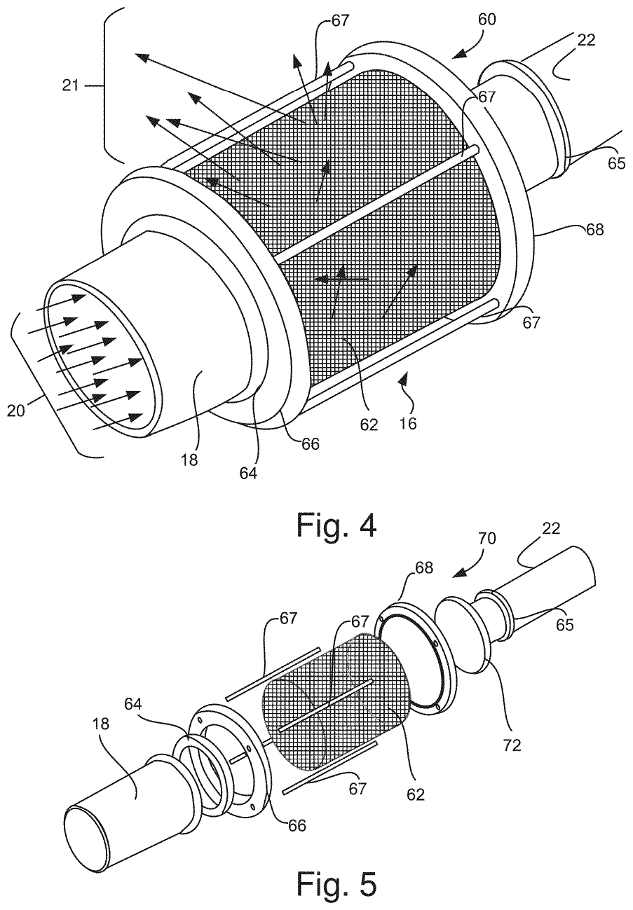

FIG. 4 is an illustration 60 of an example enclosed sieve 16. Build material of various particle sizes enter the inlet port 18 as shown by arrows into the inner cylinder void of screen 62. Screen 62 may have an array of usually uniform openings sized to allow the desired maximum allowed sized processed build material 21 which exit through various openings in screen 62 in different directions due to the different peculiar components of their velocities. The processed build material 21 exiting the screen 62 is transported by the pneumatic airflow 316 toward the outlet port 14. Accordingly, the enclosed sieve 16 provides for size segregation of build material 20 in addition to de-agglomeration and accelerated sieving.

FIG. 5 is an exploded view 70 of the example enclosed sieve 16 of FIG. 4. The inlet port 18 is coupled to the screen 62 using in one example a motion isolation bearing 64. The motion isolation bearing 64 may be housed or attached to a grooved inlet sieve screen cover 66 which fits over a first end of the screen 62. The motion isolation bearing 64 allows for the screen to be rotated without rotating the inlet. In one example, the screen 62 may be modular to be removable and allow for replacement for wear and/or exchange. For example, the screen 62 may be exchanged when a different build material is desired to be used that is chemically dis-similar from the current screen 62. The screen 62 may be fitted in one example between the grooved inlet sieve screen cover 66 and a grooved outlet sieve screen cover 68 using a set of cover screen bolts 67. In other examples, the screen 62, the two screen covers 66, 68 and the support between the two screen covers 66, 68 may all be fabricated as one piece on a 3D printing system. In other examples, just the screen 62 may be printed with a 3D printing system. Further, the screen may include structural support elements and/or fins and blades to help move the cataracting build material 20. A drive actuator 22 may be attached to the grooved sieve screen cover 68 and may include a drive actuator containing bearing 65 for mounting into a housing 12. In some examples, a motion actuator 27 is a kinetic motive source such as a motor or other motion control device, via a drive actuator 22 within or outside of housing 12 for controlling the enclosed sieve 16 operation.

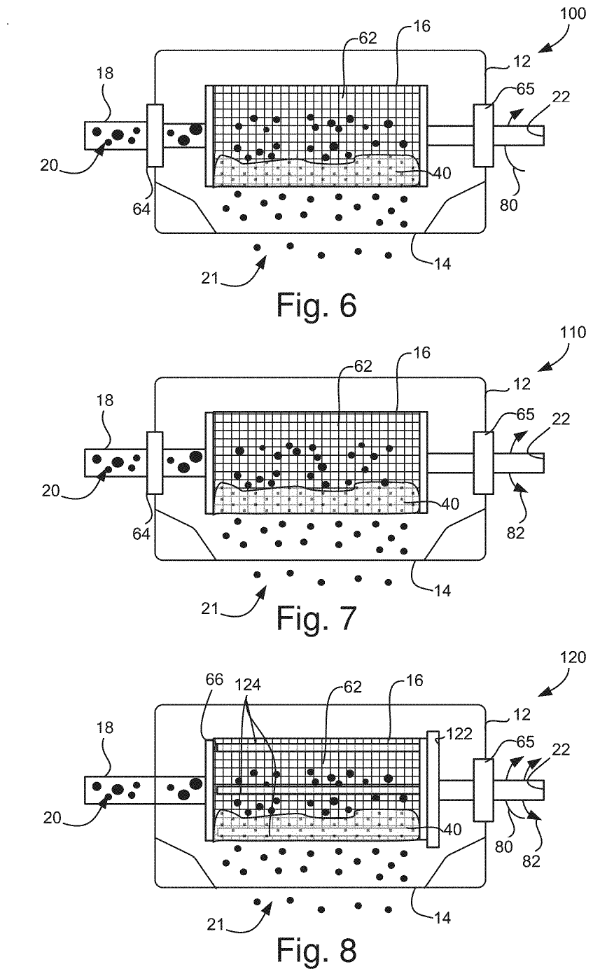

FIG. 6 is a schematic view 100 of a first type of enclosed sieve 16 operation in one example. In this example, the drive actuator 22 is rotated clockwise or counter-clockwise in one direction to breakup or de-agglomerate the build material 20 of varying sizes which flows through the inlet port 18 into the cylinder void of screen 62 and the centrifugal slug 40. The inlet port 18 is fixed and isolated from the rotating screen 62 using the motion isolation bearing 64 which is attached to housing 12. If a motion actuator 27 is outside of housing 12, the drive actuator 22 may extend from outside the housing 12 through the drive actuator container bearing 65 also attached to housing 12. However, in other examples, the drive actuator 22 of motion actuator 27 may be contained within housing 12. The motion actuator 27 may be a rotational kinetic motive source such as a motor to provide a rotation 80. The inlet port 18, the housing 12, the screen 62 and possibly the screen covers 66, 68 of enclosed sieve 16 may be formed same material as the build material 20 to provide passive de-ionization. In other examples, active de-ionization may be added as described earlier by adding sets of electrodes 24, 26 to one or both housing 12 and the inlet port. The outlet port 14 may be designed and formed to fulfill a hopper function to deliver the processed build material 21 as might be desired. A ‘hopper’ may be a container with a narrow opening at its bottom. Accordingly, the outlet port 14 design and “hopper” angles may be individually designed for each polymer species that is to be used with the device 10.

FIG. 7 is a schematic view 110 of a second type of enclosed sieve 16 operation in a second example. In this example, enclosed sieve 16 is configured the same as in FIG. 6, however, in this example the motion actuator 27 causes the drive actuator 22 to oscillate back and forth, clockwise and counter-clockwise as shown by double arrow 82 to move the centrifugal slug 40 first up one side of the cylinder and back towards the other side of the cylinder. For instance, the partial rotary motion may be 180 degrees in both directions or in other examples 90, 60, or 45 degrees in both directions though any angle between about 5 and about 180 degrees may be chosen. In other examples, the speed of the rotation and angles of rotation chosen may be such that the screen 62 is vibrating. However, more rotation and slower rotation may allow for the cataracting motion and faster de-agglomeration than simply vibrating the screen 62.

FIG. 8 is a schematic view 120 of a third type of enclosed sieve 16 operation in a third example, the enclosed sieve 16 being static. In this example, the inlet port extends from outside the housing 12 to the first cover 66 and a fixed static screen 62 at the first end of enclosed sieve 16. Static screen 62 in this example may be attached or formed within housing 12 to provide fixed support. The drive actuator 22 is coupled through the drive actuator containing bearing 65 to a blade mixer 122 at the second end of enclosed sieve 16 which may move within the static screen 62. The blade mixer 122 may have blades 124 extending into and substantially the length of the screen 62 to provide further agitation of the centrifugal slug 40. The blades 124 may be straight, curved, or otherwise shaped. The motion actuator 27 via drive actuator 22 is either a rotational kinetic motive source, such as a motor to provide a rotation 80, or a partial rotary kinetic motive source as described in FIG. 7. The blade mixer 122 and blades 124 may also be made of the same material as build material 20 to assist in providing more passive de-ionization.

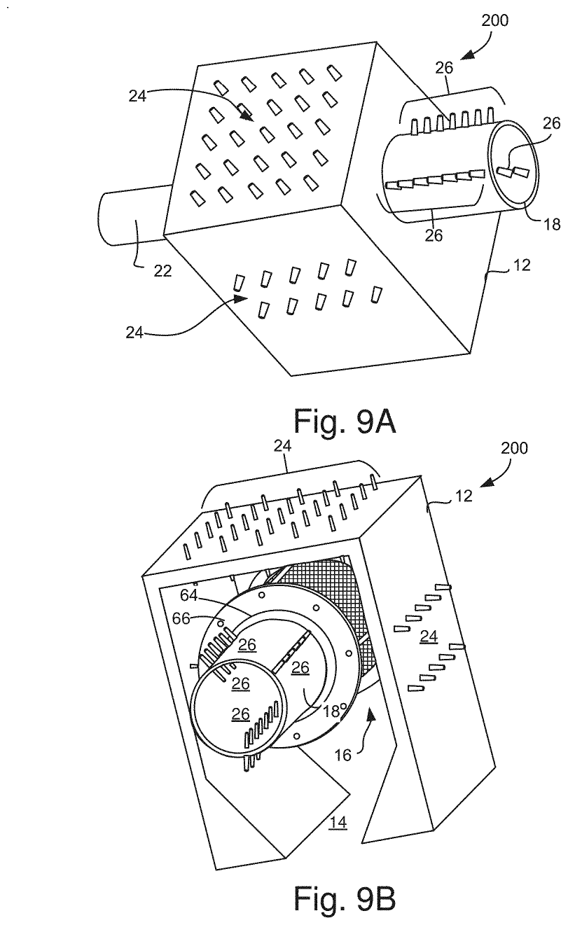

FIGS. 9A and 9B are perspective views of an example device 200 with both active and passive de-ionization along with de-agglomeration. FIG. 9A is a view showing a first set of housing electrodes 24 on the top and sides of housing 12. A second set of electrodes 26 are positioned around the inlet port 18. FIG. 9B is a view with the inlet side of housing 12 removed to show the enclosed sieve 16 disposed within the housing 12. The housing 12 has a hopper shaped outlet port 14 with angled walls to allow any processed build material 21 directed to the opening in outlet port 14. The first set of electrodes 24 on the top and side of housing 12 extend into the interior of housing 12. The second set of electrodes 26 on the inlet port 18 extend into the inside of the inlet port 18. Any or all of the housing 12, the inlet port 18, and the enclosed sieve 16 may be made of the same or a chemically-similar material as the build material 20 to be processed. The first and second set of electrodes 24, 26 may be coupled to a power source 28 to provide the active de-ionization while the passive de-ionization is provided by the build material 20 contacting the same or chemically-similar material of the housing 12, inlet port 18, and enclosed sieve 16.

FIG. 10A is a block diagram 300 of an example 3D printer system 350 with an example device 10, 200. The 3D printer system 350 includes a material feed system 306 to hold a supply of build material 20. The device 10, 200 includes an inlet port 18, a housing 12 that has an outlet port 14, and an enclosed sieve within the housing 12 that is coupled to the inlet port 18. The housing 12 and the enclosed sieve 18 are made of a polymer that same as or chemically similar to the build material 20 to provide passive de-ionization of the build material 20. A drive actuator 22 is coupled to the enclosed sieve 16 to provide for de-agglomeration of the build material 20 either by rotation, partial rotation such as by rocking back and forth, or vibration when using a motion actuator 27. A pneumatic source 310 is coupled to the material feed system 306 and the inlet port 18 to deliver the build material 20 to the device 10, 200 and to provide an airflow 316 with a positive pressure differential between the inlet port 18 and the outlet port 14 to further deliver a processed build material 21 that is de-agglomerated and de-ionized to a build area 340 of the 3D printer system 350.

FIG. 10B is a more detailed illustration of use of the example device 10, 200 of FIGS. 9A and 9B and the example enclosed sieve 16 from FIG. 4 with the 3D printing system 350 of FIG. 10A. In this example, a material feed system 306 includes a source of build material 20 stored in a hopper container 302 having an air inlet port 304 coupled to a first air valve 312 which is further coupled to a pneumatic source 310. The first air valve 312 is controlled by a controller 320. The controller 320 also controls the speed and power of pneumatic source 310. Pneumatic source 310 is also coupled to a second valve 314 which is further coupled to inlet port 18 of example device 10, 200. The second air valve 314 is also controlled by the controller 320 and in one example is activated in an alternative fashion with first air valve 312 to move blobs of build material 20 in a controlled flow to the inlet port 18 in an air assisted gravity feed system. As the blobs 20 pass the air inlet from the second valve 314 the air pressure may be designed, such as with a cyclone flow separator, to begin to break up the blobs into smaller aggregates which are further processed by the enclosed sieve 16, 62. First air valve 312 is used to control the air pressure within container 302 to enable it to allow a small amount of build material 20 to fall out of the container. In another example, the build material 20 is distributed from container 302 using a mechanical feed, such as a rotary modular gravity feed mechanism. The pneumatic source 310, or air flow mechanism, may be a fan, a blower, an air pressure tank, or a pneumatic cyclone source to provide a rotating air flow to further break up the blobs of build material 20. Accordingly, the material feed system 306 may be selected from a pneumatic cyclone separator and a modular gravity feed system.

The controller 320 has a power source coupled to the electrodes 24, 26 of the example device 200 to provide an AC source for active de-ionization. In other examples, there may not be electrodes 24, 26 for active de-ionization and just passive activation may be used. In another example, the electrodes 24, 26 may be simply grounded or connected to a DC source. The controller 320 may be also coupled to a rotary or partial rotary motion actuator 27 to provide rotary or oscillating motion, respectively to the enclosed sieve 16.

Processed build material 21 is delivered from outlet port 14 to the 3D printer system 350 working surface 342. For descriptive purposes and as non-limiting, an x, y, z coordinate system is shown with the z-axis being the up-down direction, the x-axis being a basically left-right direction, and the y-direction being basically into and out of the page direction. Other coordinate systems may of course be used but the rectangular one shown was chosen in this example for ease of discussion. For instance, the processed build material 21 is deposited down from the outlet port 14 in the z-direction. A recoater 330, a spreader bar or a roller, is used to spread in the y-direction the processed build material 21 into a build area 340 which may be moved down in the z-direction for each processed layer. After the processed build material 21 is spread, in one example a fusing agent may be placed on the spread material by a precision liquid-jet system (not shown). The fusing agent may be used to absorb energy from an energy source 332, which in this example traverses the build area 340 in the x-direction to the recoater 330. In other examples, the energy source 332 may follow the recoater 330 in the y-direction after it is parked at the far end of working surface 342 near a build material recycle return 334. In yet other examples, there may be no fusing agent and the energy source 332 is a directed energy source, such as a scanning laser, used to sinter or otherwise transfer energy to the spread processed build material 21 to cause it to form into a solid material. The build material recycle return 334 may collect any unspread processed build material 21 for return to container 302. Due to contaminants from the 3D printer process, contact with non-build material surfaces, exposure to moisture and other air-borne contaminants, the recycled processed build material 21 may have agglomerated particles before being returned to the container 302.

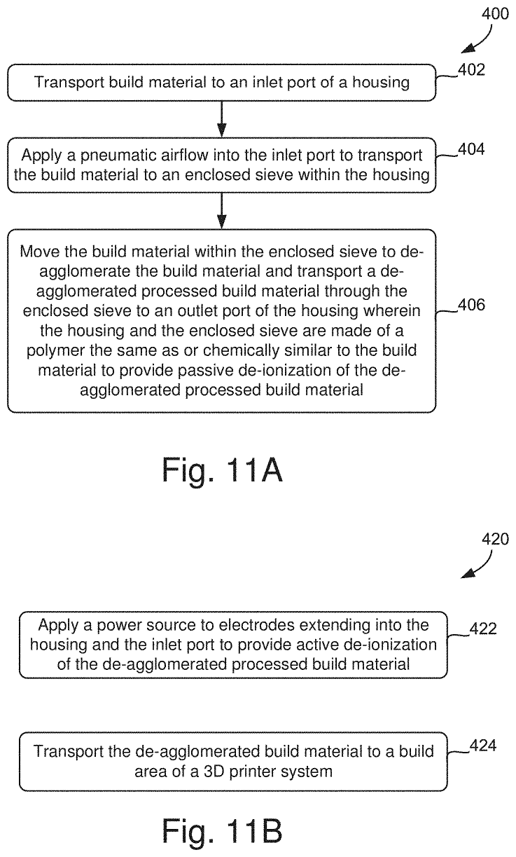

FIGS. 11A and 11B are example procedures 400, 420, respectively, that may be performed to use the example devices 10, 200 to deliver de-agglomerated and de-ionized processed build material 21. In block 402, build material 20 is transported to an inlet port 18 of a housing 12. In block 404, a pneumatic air flow 316 is applied to the inlet port 18 to transport the build material to a sieve 16 within the housing 12. In block 406, the build material 20 is moved within the sieve to de-agglomerate the material power 20 and transport the de-agglomerated build material through the sieve 16 to an outlet port 14 of the housing 12. The housing 12, the sieve 16, and the inlet port 18 may be made of a polymer the same as or chemically-similar as the build material 20 to provide passive de-electrification of the build material 20.

Other procedures for making the device 10, 200 may be included. For instance, in block 422 a power source 28 with an alternating voltage component 29 may be applied to electrodes 24, 26 extending into the housing 12 and the inlet port 18. The electrodes 24, 26 provide active de-electrification of the processed build material 21. In block 424 the de-agglomerated and de-electrified build material 21 may be transported to a 3D printer.

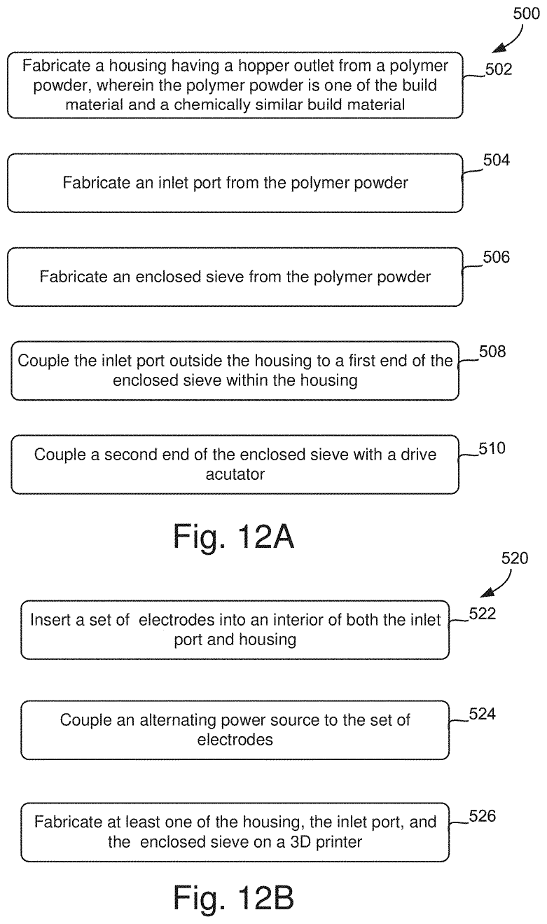

FIGS. 12A and 12B are example procedures 500, 520, respectively, that may be performed in no particular order to make an example device 10, 200 having an enclosed sieve 16 with de-ionization. In block 502, a housing 12 may be fabricated with a hopper outlet 14 from a polymer build material. The polymer build material may be one of the build material 20 or a chemically-similar build material. The polymer build material may be used to provide passive de-ionization as part of the de-electrification of the build material 20. In block 504, an inlet port 18 is fabricated from the polymer build material. In block 506 an enclosed sieve 16 is fabricated from the polymer build material. In block 508, the inlet port 18 is coupled from outside the housing 12 to a first end of the enclosed sieve 16 within the housing 12. In block 510 a second end of the enclosed sieve 16 is coupled to a drive actuator 22.

Other procedures for using the device 10, 200 may be included. For instance, in block 522 a set of electrodes 24, 26 may be inserted or applied into an interior of either or both the inlet port 18 and the housing 12. In block 524, a power source 28 with an alternating voltage component 29 may be coupled to the set of electrodes 24, 26. In block 526, at least one of the housing 12, the inlet port 18, and the enclosed sieve 16 may be fabricated on a 3D printer 350.

In summary, several devices 10, 200 to de-agglomerate and de-ionize a build material 20, different methods of making the devices 10, 200, and methods of using the devices 10, 200 have been disclosed. The devices 10, 200 may include a housing 12 that may have an outlet port 14 and an enclosed sieve 16 within the housing 12. An inlet port 18 may be coupled to a first end the enclosed sieve 16 to provide the build material 20 to the enclosed sieve 16. A drive actuator 22 may be coupled to a second end of the enclosed sieve 16. The housing 12 and the enclosed sieve 16 may be made of a polymer selected from the build material 20 and a chemically-similar polymer to the build material 20.

When device 10, 200 is used with a 3D printer system 350, the device 10, 200 may be coupled to a material feed system 306 that holds a supply of build material 20. The material feed system 306 may be coupled to a pneumatic source 310 that is further coupled to an inlet port 18 of the device 10, 200 to deliver the build material 20 to the device 10, 200 and further deliver processed build material 21 to a build area 340 of the 3D printer system 350. The delivering is done by providing an air flow 316 with a positive pressure differential between the inlet port 18 and an outlet port 14 in the housing 12 of the device 10, 200. The housing 12 and the enclosed sieve 16 are made of a polymer the same as or chemically-similar to the build material 20 to provide passive de-ionization of the build material 20. A drive actuator 22 may be coupled to an enclosed sieve 16 within the housing 12 of the device 10, 200 and may be used to de-agglomerate and de-ionize the build material 20 to provide the processed build material 21 to the build area 340.

While the claimed subject matter has been particularly shown and described with reference to the foregoing examples, those skilled in the art understand that many variations may be made therein without departing from the intended scope of subject matter in the following claims. This description may be understood to include all novel and non-obvious combinations of elements described herein, and claims may be presented in this or a later application to any novel and non-obvious combination of these elements. The foregoing examples are illustrative, and no single feature or element is to be used in all possible combinations that may be claimed in this or a later application. Where the claims recite “a” or “a first” element of the equivalent thereof, such claims may be understood to include incorporation of one or multiple such elements, neither requiring nor excluding two or more such elements.

What is claimed is:

1. A device to de-ionize a build material, comprising:
a housing including an outlet port;
an enclosed sieve within the housing;
an inlet port coupled to a first end the enclosed sieve to provide the build material; and
a drive actuator coupled to a second end of the enclosed sieve to provide de-agglomeration of the build material, wherein the housing and the enclosed sieve are made of a polymer selected from the build material and a chemically-similar polymer to the build material.

2. The device of claim 1 wherein the housing further includes a first set of electrodes inside the housing and the device further comprising a power source coupled to the first set of electrodes to provide active de-electrification of the build material.

3. The device of claim 2, further comprising:
a feedback sensor within the housing to measure ion-charge balance; and
a controller coupled to the feedback sensor and the power source wherein the controller to adjust at least one of an alternating voltage, an alternative frequency, and a direct current voltage of the power source to achieve electrical equilibrium based on measured ion-charge balance by the feedback sensor.

4. The device of claim 2 wherein the inlet port is made of the polymer and includes a second set of electrodes inside the inlet port and coupled to the power source.

5. The device of claim 1 wherein the inlet port is coupled to a material feed system to provide the build material to the enclosed sieve, and wherein the inlet port is coupled to a pneumatic source to provide an airflow with a positive pressure differential between the inlet port and the outlet port, and wherein the outlet port is a hopper outlet.

6. The device of claim 5 wherein the material feed system is selected from a pneumatic cyclone separator and a modular gravity feed.

7. The device of claim 1 wherein the housing, the enclosed sieve, and the inlet port are modular and replaceable.

8. The device of claim 1 wherein the enclosed sieve is a rotational sieve and wherein the inlet port is coupled to the housing and the first end of the enclosed sieve with a motion isolation bearing.

9. The device of claim 1 wherein the enclosed sieve is a non-rotational sieve and wherein the drive actuator is coupled at the second end of the enclosed sieve to a set of mixing blades rotatable within the enclosed sieve, the set of mixing blades made of the polymer.

10. A method of de-ionizing a build material, comprising:
transporting the build material to an inlet port of a housing;
applying a pneumatic air flow into the inlet port to transport the build material to an enclosed sieve within the housing; and
moving the build material within the enclosed sieve to de-agglomerate the build material and transport a de-agglomerated processed build material through the enclosed sieve to an outlet port of the housing wherein the housing and the enclosed sieve are made of a polymer the same as or chemically-similar to the build material to provide passive de-ionization of the de-agglomerated processed build material.

11. The method of claim 10, wherein the inlet port is made of the polymer and further comprising applying a power source to electrodes extending into the housing to provide active de-ionization of the de-agglomerated processed build material.

12. The method of claim 11, further comprising transporting the de-agglomerated processed build material to a build area of a 3D printer system.

13. A 3D printer system, comprising:
a material feed system to hold a supply of build material;
a device, including:
an inlet port,
a housing having an outlet port;
an enclosed sieve within the housing coupled to the inlet port, wherein the housing and the enclosed sieve are made of a polymer the same as or chemically-similar to the build material to provide passive de-ionization of the build material, and
a drive actuator coupled to the enclosed sieve to provide de-agglomeration of the build material; and
a pneumatic source coupled to the material feed system and the inlet port to deliver the build material to the device and to provide an airflow with a positive pressure differential between the inlet port and the outlet port to further deliver a processed build material that is de-agglomerated and de-ionized to a build area of the 3D printer system.

14. The 3D printer system of claim 13, wherein the device is modular and wherein at least one of the housing, the inlet port, and the enclosed sieve are fabricable on the 3D printer system.

15. The 3D printer system of claim 13, further comprising:
a set of electrodes within an interior of the housing; and
a power source coupled to the set of electrodes to provide active de-ionization of the processed build material.
